(19) United States
(12) Patent Application Publication
(10) Pub. No.: US 2022/0234593 A1
(43) Pub. Date: Jul. 28, 2022

(54) INTERACTION METHOD AND APPARATUS FOR INTELLIGENT COCKPIT, DEVICE, AND MEDIUM

(71) Applicant: BEIJING BAIDU NETCOM SCIENCE TECHNOLOGY CO., LTD., Beijing (CN)

(72) Inventor: Siyuan WU, BEIJING (CN)

(21) Appl. No.: 17/717,834

(22) Filed: Apr. 11, 2022

(30) Foreign Application Priority Data
Aug. 17, 2021 (CN) 202110944706.3

(51) Int. Cl. B60W 40/09; G06K 9/62

(52) U.S. Cl. CPC B60W 40/09; G06K 9/6256; B60W 2420/42; B60W 2540/22; B60W 2540/21; B60W 2540/30

(57) ABSTRACT

An interaction method for an intelligent cockpit is provided. It relates to the technical field of artificial intelligence, and in particular to intelligent interaction. An implementation is: acquiring multimodal information associated with the intelligent cockpit according to an interaction instruction of a user; preprocessing the multimodal information; determining, by using a pre-trained multimodal information alignment model, whether the preprocessed multimodal information is aligned with the interaction instruction; and determining a response strategy for the interaction instruction based on a result of the determination and the preprocessed multimodal information.

### CROSS REFERENCE TO RELATED APPLICATIONS

This application claims the benefit of Chinese Patent Application No. 202110944706.3 filed on Aug. 17, 2021, the contents of which are hereby incorporated by reference in their entireties for all purposes.

### TECHNICAL FIELD

The present disclosure relates to the technical field of artificial intelligence, in particular to intelligent interaction, and specifically to an interaction method and apparatus for an intelligent cockpit, an electronic device, a computer-readable storage medium, and a computer program product.

### BACKGROUND

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include technologies such as sensors, dedicated artificial intelligence chips, cloud computing, distributed storage, and big data processing. Artificial intelligence software technologies mainly include the following several general directions: computer vision technologies, speech recognition technologies, natural language processing technologies, and machine learning/deep learning, big data processing technologies, and knowledge graph technologies.

In terms of travel, by configuring intelligent vehicle-mounted products, a travel tool has gradually evolved into a movable intelligent travel space. The development of interaction technologies between intelligent cockpits and users will bring users a more comfortable and intelligent experience. In the related technology, there is still a lot of room for improvement in the research on interaction technologies for intelligent cockpits.

The methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The present disclosure provides a method of an interaction method and apparatus for an intelligent cockpit, an electronic device, a computer-readable storage medium, and a computer program product.

According to an aspect of the present disclosure, there is provided an interaction method for an intelligent cockpit, the method including: acquiring multimodal information associated with the intelligent cockpit according to an interaction instruction of a user; preprocessing the multimodal information; determining, by using a pre-trained multimodal information alignment model, whether the preprocessed multimodal information is aligned with the interaction instruction; and determining a response strategy for the interaction instruction based on a result of the determination and the preprocessed multimodal information.

According to another aspect of the present disclosure, there is provided an interaction apparatus for an intelligent cockpit, the apparatus including: an acquisition unit configured to acquire multimodal information associated with the intelligent cockpit according to an interaction instruction from a user in the intelligent cockpit; a preprocessing unit configured to preprocess the multimodal information; a first determination unit configured to determine, by using a pre-trained multimodal information alignment model, whether the preprocessed multimodal information is aligned with the interaction instruction; and a second determination unit configured to determine a response strategy for the interaction instruction based on a result of the determination and the preprocessed multimodal information.

According to another aspect of the present disclosure, there is provided an electronic device, including: at least one processor and a memory communicatively connected to the processor, where the memory stores commands executable by the at least one processor, and when executed by the at least one processor, the instructions cause the at least one processor to perform steps of the foregoing method.

According to another aspect of the present disclosure, there is provided a non-transitory computer-readable storage medium storing computer instructions, where the computer instructions are used to cause a computer to perform the steps of the foregoing method.

According to another aspect of the present disclosure, there is provided a computer program product including a computer program. When the computer program is executed by a processor, the steps of the foregoing method are implemented.

According to one or more embodiments of the present disclosure, responses may be made to users based on various aspects of information, and therefore, user experience can be improved.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The drawings exemplarily show embodiments and form a part of the specification, and are used to explain exemplary implementations of the embodiments together with a written description of the specification. The embodiments shown are merely for illustrative purposes and do not limit the scope of the claims. Throughout the drawings, identical reference signs denote similar but not necessarily identical elements.

FIG. 1 is a schematic diagram of an exemplary system in which various methods described herein can be implemented according to an embodiment of the present disclosure;

FIG. 2 is a schematic diagram of an interaction method for an intelligent cockpit in the related art;

FIG. 3 is a flowchart of an interaction method for an intelligent cockpit according to an embodiment of the present disclosure;

FIG. 4 is a flowchart of determining whether multimodal information is aligned with an interaction instruction in FIG. 1 according to an embodiment of the present disclosure;

FIG. 5 is a flowchart of determining a response strategy in FIG. 1 according to an embodiment of the present disclosure;

FIG. 6 is a schematic diagram of an interaction method for an intelligent cockpit according to an embodiment of the present disclosure;

FIG. 7 is a structural block diagram of an interaction apparatus for an intelligent cockpit according to an embodiment of the present disclosure; and

FIG. 8 is a structural block diagram of an exemplary electronic device that can be used to implement an embodiment of the present disclosure.

### DETAILED DESCRIPTION OF EMBODIMENTS

Exemplary embodiments of the present disclosure are described below in conjunction with the accompanying drawings, where various details of the embodiments of the present disclosure are included to facilitate understanding, and should only be considered as exemplary. Therefore, those of ordinary skill in the art should be aware that various changes and modifications can be made to the embodiments described herein, without departing from the scope of the present disclosure. Likewise, for clarity and conciseness, description of well-known functions and structures are omitted in the following descriptions.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

With the continuous development of the Internet and an AI technology, a lifestyle of human beings has been redefined, all aspects of human beings' clothing, food, housing, and travel are affected. In terms of travel, by equipping intelligent vehicle-mounted products, automobiles have entered the era of intelligent driving, and gradually evolved from a travel tool into a movable intelligent travel space. Intelligent vehicle-mounted products enable users in the vehicle to have comfortable and convenient driving and traveling experience in a narrow cabin through the information acquisition and exchange of people, roads, and vehicles.

In the related art, an intelligent cockpit has made great progress in supporting a variety of interaction modes. The intelligent cockpit has a variety of interaction functions, such as facial recognition, voice recognition, partition voice recognition, and gesture control. Users may interact with the intelligent cockpit in a variety of modes. However, each interaction function is generally based on a single information source, for example, facial detection only uses visual ability, and voice recognition only uses audio information acquired by a microphone.

A state of natural interaction between people is that when two people talk or exchange information face to face, people will give full play to their perceptual ability, acquire and understand information through vision, hearing, smell, taste, touch, perception, etc., and give final feedback by integrating information from various channels. For example, when a user tells a joke, he or she not only tells it by voice, but also dance to express his or her emotions. To bring the user a higher satisfaction, it is necessary to analyze the user's behaviors by integrating various information sources and make decisions, and give feedback of decision results based on the various information sources.

Embodiments of the present disclosure will be described below in detail in conjunction with the drawings.

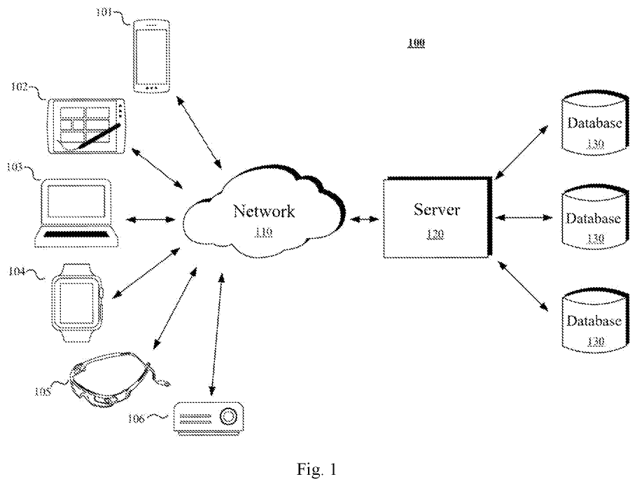

FIG. 1 is a schematic diagram of an exemplary system 100 in which various methods and apparatuses described herein can be implemented according to an embodiment of the present disclosure. Referring to FIG. 1, the system 100 includes one or more client devices 101, 102, 103, 104, 105, and 106, a server 120, and one or more communications networks 110 that couple the one or more client devices to the server 120. The client devices 101, 102, 103, 104, 105, and 106 may be configured to execute one or more application programs.

In an embodiment of the present disclosure, the server 120 can run one or more services or software applications that enable an interaction method for an intelligent cockpit to be performed.

In some embodiments, the server 120 may further provide other services or software applications that may include a non-virtual environment and a virtual environment. In some embodiments, these services may be provided as web-based services or cloud services, for example, provided to a user of the client device 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the client device 101, 102, 103, 104, 105, and/or 106 may sequentially use one or more client application programs to interact with the server 120, thereby utilizing the services provided by these components. It should be understood that various system configurations are possible, which may be different from the system 100. Therefore, FIG. 1 is an example of the system for implementing various methods described herein, and is not intended to be limiting.

The user may interact with the intelligent cockpit by using the client device 101, 102, 103, 104, 105, and/or 106. The client device may provide an interface that enables the user of the client device to interact with the client device. The client device may also output information to the user via the interface. Although FIG. 1 depicts only six types of client devices, those skilled in the art will understand that any number of client devices are possible in the present disclosure.

The client device 101, 102, 103, 104, 105, and/or 106 may include various types of computer devices, such as a portable handheld device, a general-purpose computer (such as a personal computer and a laptop computer), a workstation computer, a wearable device, a gaming system, a thin client, various messaging devices, and a sensor or other sensing devices. These computer devices can run various types and versions of software application programs and operating systems, such as MICROSOFT Windows, APPLE iOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display and other devices. The gaming system may include various handheld gaming devices, Internet-enabled gaming devices, etc. The client device can execute various application programs, such as various Internet-related application programs, communication application programs (e.g., email application programs), and short message service (SMS) application programs, and can use various communication protocols.

The network 110 may be any type of network well known to those skilled in the art, and it may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a public switched telephone network (PSTN), an infrared network, a wireless network (such as Bluetooth or Wi-Fi), and/or any combination of these and/or other networks.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures relating to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above-mentioned operating systems and any commercially available server operating system. The server 120 can also run any one of various additional server application programs and/or middle-tier application programs, including an HTTP server, an FTP server, a CGI server, a JAVA server, a database server, etc.

In some implementations, the server 120 may include one or more application programs to analyze and merge data feeds and/or event updates received from users of the client devices 101, 102, 103, 104, 105, and 106. The server 120 may further include one or more application programs to display the data feeds and/or real-time events via one or more display devices of the client devices 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases can be used to store data and other information. For example, one or more of the databases 130 can be used to store information such as an audio file and a video file. The data repository 130 may reside in various locations. For example, a data repository used by the server 120 may be locally in the server 120, or may be remote from the server 120 and may communicate with the server 120 via a network-based or dedicated connection. The data repository 130 may be of different types. In some embodiments, the data repository used by the server 120 may be a database, such as a relational database. One or more of these databases can store, update, and retrieve data from or to the database, in response to a command.

In some embodiments, one or more of the databases 130 may also be used by an application program to store application program data. The database used by the application program may be of different types, for example, may be a key-value repository, an object repository, or a regular repository backed by a file system.

The system 100 of FIG. 1 may be configured and operated in various manners, such that the various methods and apparatuses described according to the present disclosure can be applied.

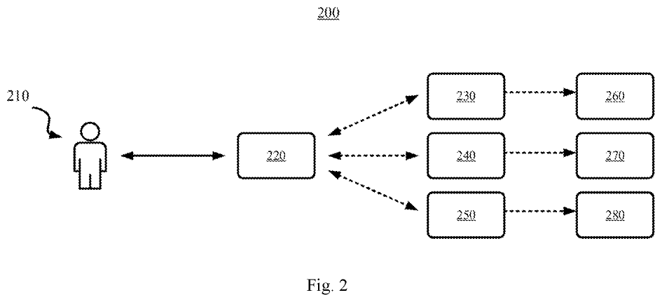

FIG. 2 is a schematic diagram of an interaction method 200 for an intelligent cockpit in the related art. As shown in FIG. 2, in the related art, a user 210 interacts with an intelligent cockpit 220 in a certain interaction mode. The interaction mode may be, for example, a voice apparatus, a visual apparatus, and a touch apparatus. The dashed arrows mean that the intelligent cockpit acquires corresponding information based on the interaction mode of the user 210. For example, when the user sends an instruction by voice, the instruction is to acquire and process audio information 230; and then generate an interaction response after interaction strategy analysis 260. Similarly, when the user sends an instruction through vision or touch, the instruction is to acquire and process video information 240 or touch information 250 and generate an interaction response after corresponding interaction strategy analysis 270 and 280.

For example, in the related art of the method 200, there is a case where responses cannot be made based on a single information source in a practical scene. For example, when the user is interacting with a vehicle including the intelligent cockpit, if the user makes a sound that is similar to a wake-up instruction word, but the user does not intend to wake up the vehicle, the vehicle may be falsely woken up. For example, in the related art, some vehicles have the function of continuous listening. Sometimes, users are chatting with people around without interacting with the vehicles, and this may be recognized by the vehicles, resulting in false responses.

According to the method 200, making decisions based on the single information source may also respond to needs of the user, but personalized experience cannot be provided. For example, when the user requests to play a song by using a voice instruction, an intelligent system may estimate a listening preference of the user and recommend related songs based on historical habits of the vehicle. However, if the driver changes, or a current emotional state of the user changes, the user wants to hear the recommended songs based on his or her current mood, which cannot be satisfied only by single voice information. For another example, nowadays, the intelligent cockpit cooperates with in-vehicle decoration, lighting, seats, etc., and provides a variety of in-vehicle atmosphere modes. When the user request to change the in-vehicle atmosphere by using voice instructions, the intelligent system converts the voice instructions into text, and performs semantic understanding and control to change the in-vehicle atmosphere randomly or strategically, without considering a current driving environment and driving state of the user.

In conclusion, if the vehicle responds not only based on voice information, but also based on vision information, for example, by determining whether a lip shape of the user is similar to a lip shape of an instruction word, or determining whether the face of the user is facing the vehicle or other people when the user speaks, the scene experience in which responses cannot be made only based on the single information may be improved, and personalized experience may be configured for different users.

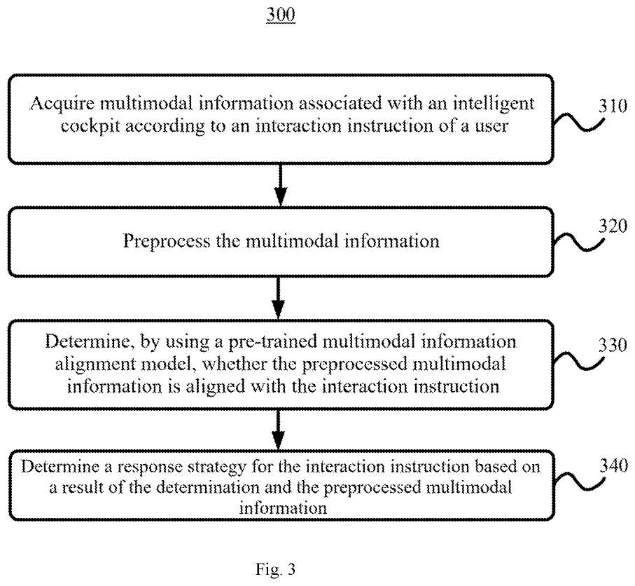

FIG. 3 is a flowchart of an interaction method 300 for an intelligent cockpit according to an embodiment of the present disclosure. As shown in FIG. 3, the method 300 includes steps 310 to 340.

In step 310, multimodal information associated with the intelligent cockpit is acquired according to an interaction instruction of a user. In an example, the user may send the interaction instruction to the intelligent cockpit in various modes, such as a voice apparatus, a visual apparatus, and a touch apparatus. However, the intelligent cockpit does not merely acquire information about the same mode as the user, but acquires multimodal information associated with the intelligent cockpit.

In some exemplary embodiments, the intelligent cockpit includes a vehicle-mounted information system including a microphone, a camera, and a touch apparatus, and the multimodal information associated with the intelligent cockpit includes at least one of the following: audio information acquired by the microphone; video information acquired by the camera; touch information sensed by the touch apparatus; and vehicle status information of the vehicle with the intelligent cockpit. For example, visually, the vehicle is equipped with a multi-directional camera to capture a video of a behavior of the user; auditorily, the audio information of the user is acquired by the microphone; and tactilely, pulses, a temperature, and other information of the user may be sensed by a sensor on a steering wheel. In an example, when the user sends an interaction instruction to the intelligent cockpit by voice, the intelligent cockpit does not merely acquire voice information, but acquires information about other modalities at the same time, for example, acquiring the vision information by the camera, and sensing the touch information and the vehicle status information by the touch apparatus. In an example, the vision information may include information such as a posture and an expression of the user. The touch information may include information characterizing physiological states, such as a temperature and pulses of the user. Driving state information may include data related to non-users, such as a current geographical location, a current vehicle status (such as an in-vehicle temperature, and a fuel level), and the number of passengers in the vehicle.

In step 320, the multimodal information is preprocessed. In step 310, the multimodal information may be acquired by the intelligent cockpit. Since, for example, original audio data and video data in the multimodal information each have a separate data form, corresponding preprocessing needs to be performed to normalize or unify the multimodal information. In some exemplary embodiments, the multimodal information may be preprocessed by using a plurality of pre-trained corresponding module information processing models. For example, voice information is preprocessed by a pre-trained voice information processing model, and video information is preprocessed by a pre-trained video information processing model.

In step 330, whether the preprocessed multimodal information is aligned with the interaction instruction is determined by using a pre-trained multimodal information alignment model. In an example, whether the interaction instruction of the user is aligned with the acquired and preprocessed multimodal information may be determined to rule out some false responses. For example, in the method 200, when the interaction instruction sent by the user is similar to wake-up, the intelligent cockpit only relies on the voice information to make a false response to wake-up. In an example, through step 330, the intelligent cockpit may align acquired information such as vision information, vehicle status information, and other information with the interaction instruction of the user, and when it is found that, for example, a mouth shape of the user does not match the wake-up or the vehicle has been woken up, it may be determined that the vision information or vehicle status information is not aligned with the interaction instruction, which can be used for subsequent determination of a response strategy.

In step 340, a response strategy for the interaction instruction is determined based on a result of the determination and the preprocessed multimodal information.

In conclusion, the interaction method 300 based on multimodal information can comprehensively understand the behavior of the user and give feedback by acquiring multi-directional information from, for example, vision, hearing, touch, and perception. Based on user behavior data acquired by cameras, microphones, touch apparatuses, and other channels, the intelligent cockpit can make comprehensive decisions and give more intelligent response strategies, thereby improving the user experience.

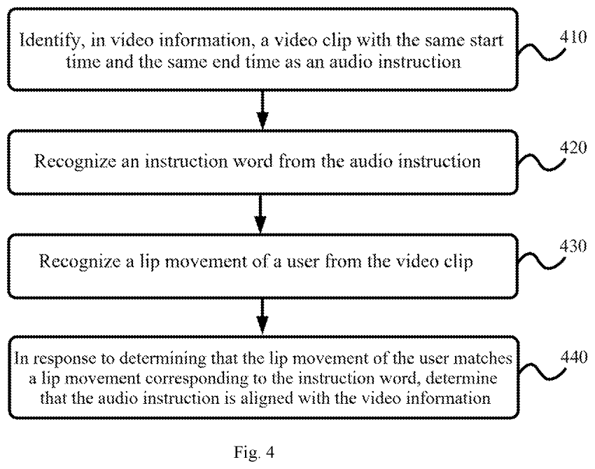

FIG. 4 is a flowchart of determining whether multimodal information is aligned with an interaction instruction in FIG. 1 according to an embodiment of the present disclosure. As shown in FIG. 4, whether the preprocessed multimodal information is aligned with the interaction instruction being determined (step 330) includes steps 410 to 440.

In step 410, a video clip with the same start time and the same end time as the audio instruction is identified in the video information. In an example, the video information and the audio instruction may be processed based on the start time and the end time to identify the video clip related to the audio instruction in the video information. For example, when the user sends an interaction instruction by saying a sentence, a video clip with the same start time and end time as the sentence is obtained.

In step 420, an instruction word is recognized from the audio instruction. In an example, voice analysis may be performed on the audio instruction to recognize the instruction word.

In step 430, a lip movement of the user is recognized from the video clip. In an example, the lip movement of the user may be recognized through feature extraction or other image processing methods.

In step 440, in response to a determination that the lip movement of the user matches a lip movement corresponding to the instruction word, it is determined that the audio instruction is aligned with the video information. In an example, a pre-trained matching model may be used to match the extracted instruction word with the lip movement of the user. For example, when the user sends an instruction word “0”, a matching model can determine whether the lip movement of the user at that moment matches a lip movement for sending the instruction word “0”.

In conclusion, the embodiments of the present application can rule out some misjudgments by matching the instruction word of the user with the lip movement of the user. For example, when the user makes a voice similar to wake-up, but the recognized wake-up instruction word does not match the lip movement of the user in the video, a response to the wake-up may be ruled out. Therefore, the embodiment of the present application can reduce the misjudgment of response decision and improve the user experience.

In some exemplary embodiments, whether the preprocessed multimodal information is aligned with the interaction instruction being determined (step 330) may further include: performing semantic analysis and semantic understanding on the audio information to extract a corresponding instruction intention; and in response to the instruction intention matching the vehicle status information, determining that the audio instruction is aligned with the vehicle status information. Taking the interaction instruction of the user as the audio instruction as an example, a pre-trained semantic analysis model and semantic understanding model may be used to process the audio instruction to extract the corresponding instruction intention. For example, when the user sends an interaction instruction “I want to refuel”, an extracted instruction intention may be that the user wants to refuel the vehicle. According to the method 200 in the related art, the intelligent cockpit feeds back an interaction strategy of information about a nearby gas station to the user. However, according to the embodiment of the present application, the vehicle status information will be matched with the instruction intention. For example, when data related to refueling in the vehicle status information shows that the fuel level of the vehicle is sufficient, it can be determined that the interaction instruction of the user cannot be aligned, and this can be used for subsequent analysis for response strategies and exclusion of feedback of refueling information.

In conclusion, the embodiment of the present application can effectively rule out some unreasonable response strategies by matching the instruction intention of the user with the vehicle status. For example, when the fuel is sufficient, the information about the gas station is still fed back to the user. Therefore, the embodiment of the present application can reduce the misjudgment of response decision and improve the user experience.

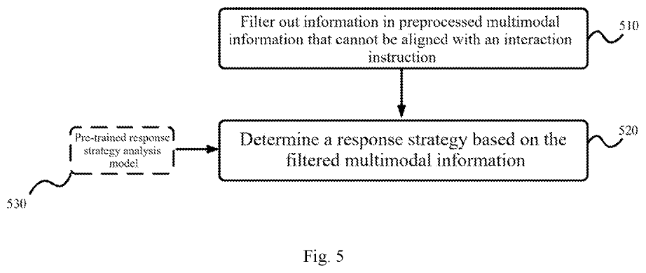

FIG. 5 is a flowchart of determining a response strategy in FIG. 1 according to an embodiment of the present disclosure. As shown in FIG. 5, a response strategy for the interaction instruction being determined (step 340) includes steps 510 and 520.

In step 510, information in the preprocessed multimodal information that cannot be aligned with the interaction instruction is filtered out. In an example, which information in the multimodal information is aligned with the interaction instruction and which information is not aligned with the interaction instruction may be determined by using different alignment determination methods. Then, information that cannot be aligned, that is, information that is different from information conveyed by the data is filtered out.

In step 520, the response strategy is determined based on the filtered multimodal information. In some exemplary embodiments, the response strategy may be determined by processing the filtered multimodal information by using a pre-trained response strategy analysis model 530. The response strategy may include at least one of an interaction strategy and an execution strategy.

Therefore, the embodiments of the present application can filter out, in advance, information that cannot be aligned, thereby improving accuracy of responding to the intention of the user by the response strategy.

In some exemplary embodiments, the interaction strategy may include replying to the user with a script, and parameters of replying with the script are obtained by the pre-trained response strategy analysis model, and include at least one of the following: a script timbre parameter; a script gender parameter; a script age parameter; a script style parameter; an appearance parameter; an expression parameter; and an action parameter. In one example, the response strategy analysis model can generate different interaction strategies for different users through video information including a user. For example, different timbre styles are generated for different genders and ages. For another example, in an intelligent cockpit including a virtual assistant, different images or expressions are fed back to different users. Therefore, in the consideration of multimodal information, the embodiment of the present application can comprehensively understand the needs of users, thereby providing personalized interaction experience for users.

In some exemplary embodiments, the response strategy fed back to the user includes an execution strategy, and the execution strategy includes: controlling a hardware system or software system of the vehicle with the intelligent cockpit to respond to the interaction instruction. For example, a vehicle window is opened in response to instruction information “open the window” of the user. For example, in response to the instruction information “lower an air-conditioning temperature” of the user, and acquired user skin temperature information, vehicle status information, and the like have no inconsistent/misaligned information, a vehicle air-conditioning system is controlled to lower the air-conditioning temperature. For another example, in response to the instruction information “listen to music” of the user, music to be played to the user is comprehensively decided by using the information about the user identified in the video information and a music playing history in the vehicle status information. Therefore, the embodiment of the present application can improve interaction experience of users.

In some exemplary embodiments, in response to the filtered multimodal information being an empty set, the interaction instruction is not responded to. For example, if the instruction word “refuel” of the user conflicts with remaining fuel level information, the instruction of the user is not responded to. For another example, when it is determined from the video information that the user is talking to people around him or her, instead of sending a specific instruction to the intelligent cockpit, the instruction of the user is not responded to. In conclusion, the embodiments of the present application can avoid false responses, to be ready to respond to customers more effectively.

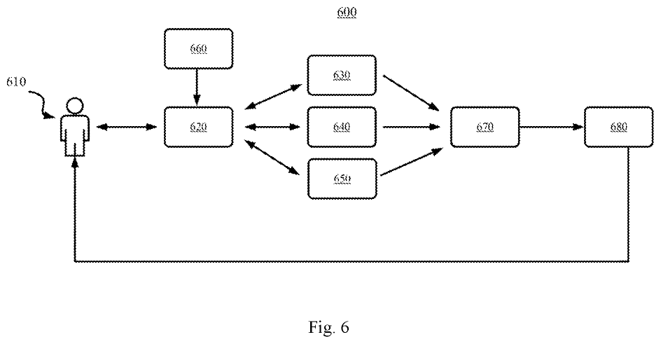

FIG. 6 is a schematic diagram of an interaction method 600 for an intelligent cockpit according to an embodiment of the present disclosure. FIG. 6 shows differences between the embodiment of the present disclosure and the related art of FIG. 2. As shown in FIG. 6, a user 610 sends voice instructions to an intelligent cockpit 620 in various modes. The intelligent cockpit 620 acquires and preprocesses multimodal information including audio information 630, video information 640, touch information 650, and vehicle status information 660. A multimodal information alignment model 670 determines whether the preprocessed multimodal information is aligned with the interaction instruction. An interaction strategy analysis model generates a response strategy after information that cannot be aligned is filtered out. Finally, a vehicle interacts with the user according to the response strategy.

In conclusion, the interaction method for an intelligent cockpit based on the multimodal information according to the present disclosure comprehensively understands the needs of the user by considering the multimodal information from vision, touch, and hearing. The interaction method in the present disclosure is helpful for accurately responding to a misjudgment scenario based on a single information source, or bringing personalized feedback and interaction experience for the user in different states.

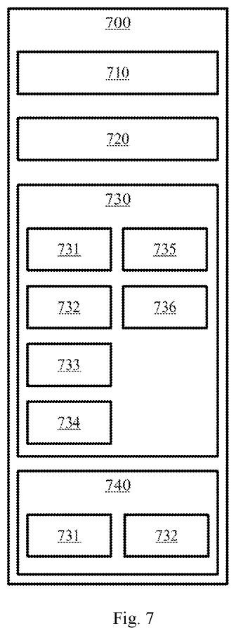

FIG. 7 is a structural block diagram of an interaction apparatus 700 for an intelligent cockpit according to an embodiment of the present disclosure. As shown in FIG. 7, the interaction apparatus 700 includes an acquisition unit 710, a preprocessing unit 720, a first determination unit 730, and a second determination unit 740.

The acquisition unit 710 is configured to acquire multimodal information associated with the intelligent cockpit according to an interaction instruction from a user in the intelligent cockpit.

The preprocessing unit 720 is configured to preprocess the multimodal information.

The first determination unit 730 is configured to determine, by using a pre-trained multimodal information alignment model, whether the multimodal information is aligned with the interaction instruction.

The second determination unit 740 is configured to determine a response strategy for the interaction instruction based on a result of the determination and the multimodal information.

In some exemplary embodiments, the intelligent cockpit includes a vehicle-mounted information system including a microphone, a camera, and a touch apparatus, and the multimodal information associated with the intelligent cockpit includes at least one selected from the group consisting of: audio information acquired by the microphone; video information acquired by the camera; touch information sensed by the touch apparatus; and vehicle status information of the vehicle with the intelligent cockpit.

In some exemplary embodiments, the first determination unit 730 includes an identification subunit 731, a first recognition subunit 732, a second recognition subunit 733, and a first determination subunit 734.

The identification subunit 731 is configured to identify, in the video information, a video clip with the same start time and the same end time as an audio instruction.

The first recognition subunit 732 is configured to recognize an instruction word from the audio instruction.

The second recognition subunit 733 is configured to recognize a lip movement of the user from the video clip.

The first determination subunit 734 is configured to: in response to determining that the lip movement of the user matches a lip movement corresponding to the instruction word, determine that the audio instruction is aligned with the video information.

In some exemplary embodiments, the first determination subunit 730 includes an extraction subunit 735 and a second determination subunit 736.

The extraction subunit is configured to perform semantic analysis and semantic understanding on the audio information to extract a corresponding instruction intention.

The second determination subunit is configured to: in response to the instruction intention matching the vehicle status information, determine that the audio instruction is aligned with the vehicle status information.

In some exemplary embodiments, the first determination unit 730 includes a filtering subunit 735 and a third determination subunit 736.

The filtering subunit is configured to filter out information in the preprocessed multimodal information that cannot be aligned with the interaction instruction; and

the third determination subunit is configured to determine the response strategy based on the filtered multimodal information.

In some exemplary embodiments, the interaction strategy includes replying to the user with a script, and parameters of replying with the script are obtained by the pre-trained response strategy analysis model, and include at least one selected from the group consisting of: a script timbre parameter; a script gender parameter; a script age parameter; a script style parameter; an appearance parameter; an expression parameter; and an action parameter.

In some exemplary embodiments, the execution strategy includes: controlling a hardware system or software system of the vehicle with the intelligent cockpit to respond to the interaction instruction.

In the technical solutions of the present disclosure, collecting, storage, use, processing, transmitting, providing, disclosing, etc. of personal information of a user involved all comply with related laws and regulations and are not against the public order and good morals.

According to the embodiments of the present disclosure, there are further provided an electronic device, a readable storage medium, and a computer program product.

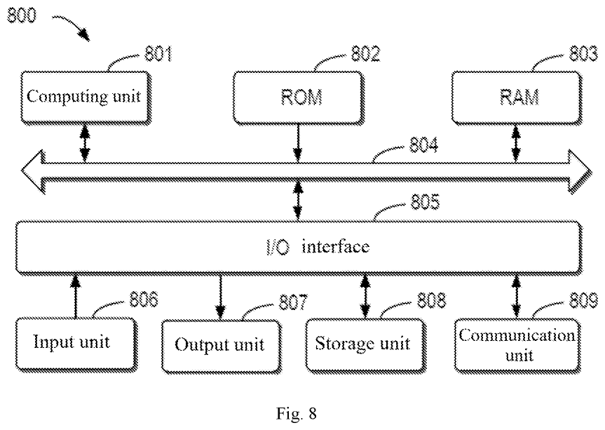

Referring to FIG. 8, a structural block diagram of an electronic device 800 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 8, the device 800 includes a computing unit 801, which may perform various appropriate actions and processing according to a computer program stored in a read-only memory (ROM) 802 or a computer program loaded from a storage unit 808 to a random access memory (RAM) 803. The RAM 803 may further store various programs and data required for the operation of the device 800. The computing unit 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, an output unit 807, the storage unit 808, and a communication unit 809. The input unit 806 may be any type of device capable of entering information to the device 800. The input unit 806 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 807 may be any type of device capable of presenting information, and may include, but is not limited to, a display, a speaker, a video/audio output terminal, a vibrator, and/or a printer. The storage unit 808 may include, but is not limited to, a magnetic disk and an optical disc. The communication unit 809 allows the device 800 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, a 1302.11 device, a Wi-Fi device, a WiMAX device, a cellular communication device, and/or the like.

The computing unit 801 may be various general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 801 performs the various methods and processing described above, for example, the method 300. For example, in some embodiments, the method 300 may be implemented as a computer software program, which is tangibly contained in a machine-readable medium, such as the storage unit 808. In some embodiments, a part or all of the computer program may be loaded and/or installed onto the device 800 via the ROM 802 and/or the communication unit 809. When the computer program is loaded onto the RAM 803 and executed by the computing unit 801, one or more steps of the method 300 described above can be performed. Alternatively, in other embodiments, the computing unit 801 may be configured, by any other suitable means (for example, by means of firmware), to perform the method 300.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the drawings, it should be appreciated that the methods, systems, and devices described above are merely exemplary embodiments or examples, and the scope of the present disclosure is not limited by the embodiments or examples, but only defined by the appended authorized claims and equivalent scopes thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. An interaction method for an intelligent cockpit, the method comprising:
acquiring multimodal information associated with the intelligent cockpit according to an interaction instruction of a user;
preprocessing the multimodal information to generate preprocessed multimodal information;
determining, using a pre-trained multimodal information alignment model, whether the preprocessed multimodal information is aligned with the interaction instruction; and
determining a response strategy for the interaction instruction based on a result determining whether the preprocessed multimodal information is aligned with the interaction instruction.

2. The method according to claim 1, wherein the intelligent cockpit comprises a vehicle-mounted information system in a vehicle, the vehicle-mounted information system comprising a microphone, a camera, and a touch apparatus, and the multimodal information associated with the intelligent cockpit comprises at least one of:
audio information acquired by the microphone;
video information acquired by the camera;
touch information sensed by the touch apparatus; or
vehicle status information of the vehicle with the intelligent cockpit.

3. The method according to claim 2, wherein the interaction instruction comprises an audio instruction, the multimodal information comprises the video information, and the determining whether the preprocessed multimodal information is aligned with the interaction instruction comprises:
identifying, in the video information, a video clip with a same start time and a same end time as the audio instruction;
recognizing an instruction word from the audio instruction;
recognizing a lip movement of the user from the video clip; and
in response to determining that the lip movement of the user matches a lip movement corresponding to the instruction word, determining that the audio instruction is aligned with the video information.

4. The method according to claim 2, wherein the interaction instruction comprises an audio instruction, the multimodal information comprises the vehicle status information, and the determining whether the preprocessed multimodal information is aligned with the interaction instruction comprises:
performing semantic analysis and semantic understanding on the audio information to extract a corresponding instruction intention; and
in response to the instruction intention matching the vehicle status information, determining that the audio instruction is aligned with the vehicle status information.

5. The method according to claim 1, wherein the determining a response strategy for the interaction instruction comprises:
filtering out information in the preprocessed multimodal information that cannot be aligned with the interaction instruction to generate filtered multimodal information; and
determining the response strategy based on the filtered multimodal information.

6. The method according to claim 5, wherein the determining the response strategy comprises:
determining the response strategy by processing the filtered multimodal information using a pre-trained response strategy analysis model, wherein the response strategy comprises at least one of an interaction strategy and an execution strategy.

7. The method according to claim 6, wherein the interaction strategy comprises replying to the user with a script, and parameters of replying with the script are obtained by the pre-trained response strategy analysis model, and comprise at least one of the following: a script timbre parameter, a script gender parameter, a script age parameter, a script style parameter, an appearance parameter, an expression parameter, or an action parameter.

8. The method according to claim 6, wherein the execution strategy comprises controlling a hardware system or software system of the vehicle with the intelligent cockpit to respond to the interaction instruction.

9. The method according to claim 5, wherein the determining the response strategy comprises:
in response to the filtered multimodal information being an empty set, skipping responding to the interaction instruction.

10. The method according to claim 1, wherein the preprocessing the multimodal information comprises:
preprocessing the multimodal information using a plurality of pre-trained corresponding information processing models.

11. An electronic device, comprising:
at least one processor; and
a memory communicatively connected to the at least one processor, wherein the memory stores instructions executable by the at least one processor, and when executed by the at least one processor, the instructions cause the at least one processor to perform an interaction method for an intelligent cockpit, the method comprising:
acquiring multimodal information associated with the intelligent cockpit according to an interaction instruction of a user;
preprocessing the multimodal information to generate preprocessed multimodal information;
determining, using a pre-trained multimodal information alignment model, whether the preprocessed multimodal information is aligned with the interaction instruction; and
determining a response strategy for the interaction instruction based on a result determining whether the preprocessed multimodal information is aligned with the interaction instruction.

12. The electronic device according to claim 11, wherein the intelligent cockpit comprises a vehicle-mounted information system in a vehicle, the vehicle-mounted information system comprising a microphone, a camera, and a touch apparatus, and the multimodal information associated with the intelligent cockpit comprises at least one of the following:
audio information acquired by the microphone;
video information acquired by the camera;
touch information sensed by the touch apparatus; or
vehicle status information of the vehicle with the intelligent cockpit.

13. The electronic device according to claim 12, wherein the interaction instruction comprises an audio instruction, the multimodal information comprises the video information, and the determining whether the preprocessed multimodal information is aligned with the interaction instruction comprises:
identifying, in the video information, a video clip with the same start time and the same end time as the audio instruction;
recognizing an instruction word from the audio instruction;
recognizing a lip movement of the user from the video clip; and
in response determining that the lip movement of the user matches a lip movement corresponding to the instruction word, determining that the audio instruction is aligned with the video information.

14. The electronic device according to claim 12, wherein the interaction instruction comprises an audio instruction, the multimodal information comprises the vehicle status information, and the determining whether the preprocessed multimodal information is aligned with the interaction instruction comprises:
performing semantic analysis and semantic understanding on the audio information to extract a corresponding instruction intention; and
in response to the instruction intention matching the vehicle status information, determining that the audio instruction is aligned with the vehicle status information.

15. The electronic device according to claim 11, wherein the determining a response strategy for the interaction instruction comprises:
filtering out information in the preprocessed multimodal information that cannot be aligned with the interaction instruction to generate filtered multimodal information; and
determining the response strategy based on the filtered multimodal information.

16. The electronic device according to claim 15, wherein the determining the response strategy comprises:
determining the response strategy by processing the filtered multimodal information using a pre-trained response strategy analysis model, wherein the response strategy comprises at least one of an interaction strategy and an execution strategy.

17. The electronic device according to claim 16, wherein the interaction strategy comprises replying to the user with a script, and parameters of replying with the script are obtained by the pre-trained response strategy analysis model, and comprise at least one of: a script timbre parameter, a script gender parameter, a script age parameter, a script style parameter, an appearance parameter, an expression parameter, or an action parameter.

18. The electronic device according to claim 16, wherein the execution strategy comprises controlling a hardware system or software system of the vehicle with the intelligent cockpit to respond to the interaction instruction.

19. The electronic device according to claim 15, wherein the determining the response strategy comprises:
in response to the filtered multimodal information being an empty set, skipping responding to the interaction instruction.

20. A non-transitory computer-readable storage medium storing computer instructions, wherein the computer instructions, when executed by one or more processors, are used to cause a computer to perform an interaction method for an intelligent cockpit, the method comprising:
acquiring multimodal information associated with the intelligent cockpit according to an interaction instruction of a user;
preprocessing the multimodal information to generate preprocessed multimodal information;
determining, by using a pre-trained multimodal information alignment model, whether the preprocessed multimodal information is aligned with the interaction instruction; and
determining a response strategy for the interaction instruction based on a result of determining whether the preprocessed multimodal information is aligned with the interaction instruction.
